(19) United States
(12) Patent Application Publication
(10) Pub. No.: US 2017/0337775 A1
(43) Pub. Date: Nov. 23, 2017

(54) SYSTEMS AND METHODS OF PROVIDING A GAMING SYSTEM ACCESSIBLE VIA A GLOBAL COMPUTER NETWORK

(71) Applicant: High 5 Games, LLC, New York, NY (US)

(72) Inventors: Anthony Singer, New York, NY (US); Med Nadooshan, Brooklyn, NY (US); A Stuart Zoble, New York, NY (US)

(73) Assignee: High 5 Games, LLC, New York, NY (US)

(21) Appl. No.: 15/387,155

(22) Filed: Dec. 21, 2016

Related U.S. Application Data
(63) Continuation of application No. 13/891,142, filed on May 9, 2013, now abandoned.
Application No. 13/891,142 is a continuation of application No. 61/645,042, filed on May 9, 2012.

(51) Int. Cl. G07F 17/32

(52) U.S. Cl. CPC G07F 17/3267

(57) ABSTRACT

A machine comprising: a reward campaign engine; a plurality of user configurations, stored on a memory, wherein each user configuration comprises: an index to a plurality of games wherein the index comprises a game access status for each game; and a user credit balance; a user interface enabling a user to play the games whose game access status is unlocked at any time and not enabling the user to play the games whose game access status is locked wherein the outcome of the games affects the user credit balance; and an event, triggered by the reward campaign engine, wherein the occurrence of the event modifies the user configuration.

### CROSS-REFERENCE TO RELATED APPLICATIONS

This application claims priority to U.S. patent application Ser. No. 13/891,142, filed May 9, 2013, now pending, which claims priority to U.S. Provisional Patent Application Ser. No. 61/645,042, filed May 9, 2012, entitled “Systems and Methods of Providing a Gaming System Accessible via a Global Computer Network,” the disclosure of which is incorporated herein by reference in its entirety.

### BACKGROUND

### Field of the Invention

Embodiments of the present disclosure generally relate to systems and methods of providing a gaming system accessible via a global computer network. More specifically, embodiments of the present invention relate to a system and method for providing multiple users access to a multi-game gaming network in a social network environment, having unique means for accessing, playing, and ranking in individual games within the gaming network.

### Description of Related Art

In many known social platform-based games, achieving a next level or feature within the game often requires a player to attain a certain score, performance level, or the like. Often, this requires countless hours of game play, which can become frustrating to a player. This is particularly true if the player only wishes to play the hard-to-reach level or feature, but does not want to spend all their time getting to that level. Thus, there is a need for a system and method of providing a gaming system accessible via a global computer network, such as the systems and methods disclosed herein.

### SUMMARY

Embodiments of the present disclosure generally relate to systems and methods of providing a gaming system accessible via a global computer network. More specifically, embodiments of the present invention relate to a system and method for providing multiple users access to a multi-game gaming network in a social network environment, having unique means for accessing, playing, and ranking in individual games within the gaming network.

A system of providing a gaming system accessible via a global computer network, the system comprising: an administrator comprising a host computer, accessible via a global computer network, the host computer comprising a tangible computer readable medium comprising program instructions, wherein the program instructions are computer-executable to implement: hosting a gaming platform, whereby the gaming platform comprises access to plurality of locked games and at least one unlocked game; enabling a first user to play an unlocking game of chance provided through a graphical user interface of the gaming platform; enabling the user to unlock one of the plurality of locked games upon a predetermined outcome of the unlocking game of chance; and enabling the user to play an unlocked game via the gaming platform.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level network diagram of system for a gaming system accessible via a global computer network in accordance with one embodiment of the present invention;

FIG. 2 depicts a block diagram of a general computer system, capable of being utilized in connection with the system depicted in FIG. 1, in accordance with another embodiment of the present invention; and

FIG. 3 depicts a graphical display of an exemplary screenshot in accordance with one embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the Figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to systems and methods of providing a gaming system accessible via a global computer network. More specifically, embodiments of the present invention relate to a system and method for providing multiple users access to a multi-game gaming network in a social network environment, having unique means for accessing, playing, and ranking in individual games within the gaming network.

As used herein, the term “multimedia data” refers to any type of data that may reasonably be construed as a media data type, including specifically, audio data (e.g., sound bites, music, or the like), visual data (e.g., photographs, graphics, videos, or the like), text data (e.g., as entered by a user from an input device), barcode data (e.g., as commonly found on tickets, labels, or the like), radio frequency identification (RFID) data, geographic and/or directional data (e.g., as reported from a Global Positioning System (GPS) or a preprogrammed routing source, often in the form of coordinates, or relationship positioning), or the like. As understood by the embodiments disclosed herein, any discussion of one particular form of multimedia data or data, shall be inclusive of any other type of multimedia data as defined above.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

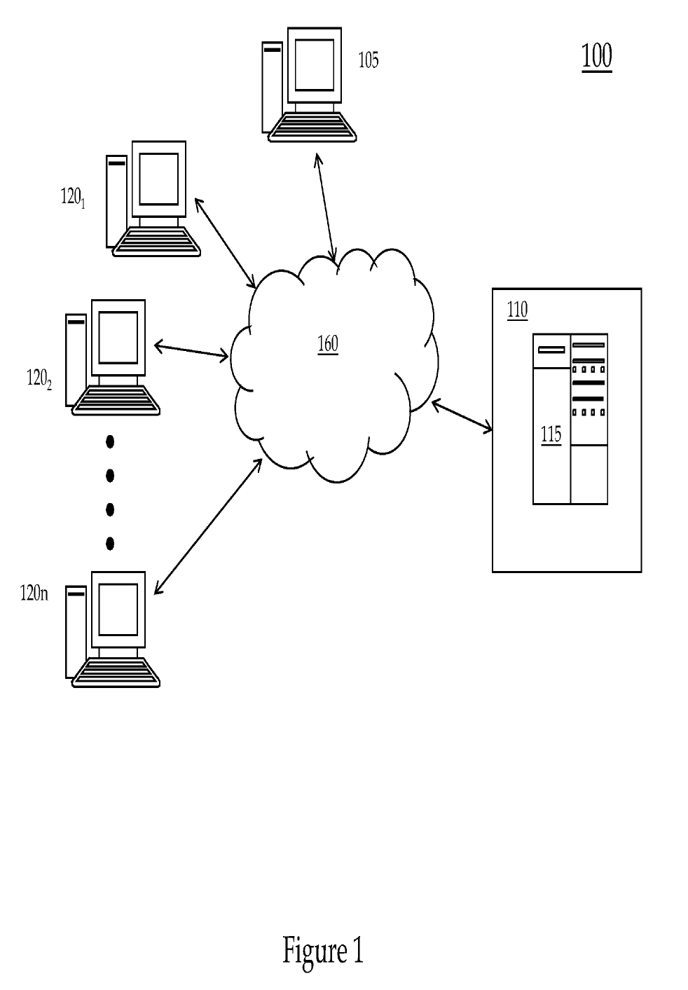

FIG. 1 depicts a system-level network diagram of system of providing a gaming system in accordance with one embodiment of the present invention. The system 100 generally comprises at least a first user 105 and secondary users 1201 and 1202, each in communication with an administrator 110, generally hosting a central server 115 or database, through a network 160, which may comprise a global computer network, for example, the Internet.

In exemplary embodiments, there is a user configuration for each user which stores information about the player, including a user player level, an index to games, game access status, game level, and the like.

As is common in network-based business models, the administrator 110 may also comprise a web administrator, responsible for providing and maintaining a website or interactive portal through which all of the users of the system 100 may interact and execute the methodology and functionality disclosed in the embodiments disclosed herein. In other embodiments, the administrator 110 may comprise an application or software administrator, responsible for providing content to or through an application or software hosted on or made available by a third party, such as a social network.

Although FIG. 1 explicitly depicts three secondary users (labeled “User 2” 1201, “User 3” 1202, and “User N” 120N), it should be appreciated that N represents any number of users feasible in accordance with embodiments of the present invention. For ease of reference, as used herein, each of the terms “second user” or “secondary user” may refer to any one or all of the users 1201, 1202, and 120N within the system 100. Likewise, although FIG. 1 explicitly depicts only one first user 105, there may be more than one first user 105 in accordance with certain embodiments of the present invention. That is, in certain embodiments, multiple users, including the secondary users, may perform the same or similar functions as the first user 105. As understood by embodiments of the present invention, a user may include any person, business or entity, capable of participating in the system and methods disclosed herein.

The first user 105 generally has an interest in playing games via the system 100. The games may comprise any type of computer-hosted games suitable for embodiments of the present invention. In many embodiments, the games comprise one or more of sports games (e.g., multi-sport events, Olympic games, etc.), board games, card games, casino-type games, dice games, role-playing games, chess/checkers games, alternate reality games, educational games, letter/number games, mathematical games, guessing games, word games, or the like. In some embodiments, the games comprise wagering (i.e., gambling) and/or non-wagering casino-type games (e.g., poker, blackjack, slots, craps, roulette, etc.). In one embodiment, the games comprise a multitude of various slots-type casino games.

In a basic exemplary embodiment, within the system 100, a first user 105 may be capable of transmitting data regarding the event to the administrator 110, using a mobile device. The mobile device in the context of this application may include, but is not limited to a smartphone, an Apple iPhone, a Blackberry device, Personal Data Assistant (PDA), a netbook, a mobile computer or the like, or may generally include a general purpose computer, or components thereof as discussed below.

As explained above, the network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

Optionally, a third party commercial server (not shown) may be in communication with the system 100 through the network 160 to carry out certain features of embodiments of the present invention, as explained below. In accordance with embodiments of the present invention, such third party commercial servers may be administered by financial institutions (e.g., banks, credit card companies, or the like), advertisers (e.g., any third party offering banner ads or displayed offers), local merchants (e.g., providing information regarding an area around a venue), social networking sites (e.g., Facebook, MySpace, Twitter, FourSquare or the like), global positioning system administrators, or the like.

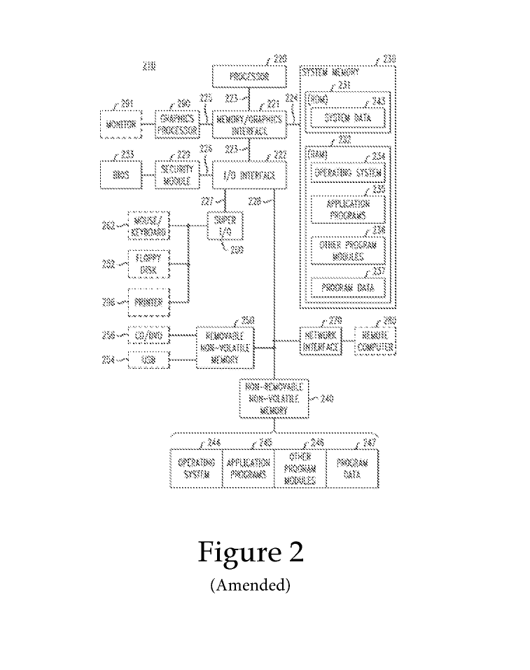

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarly in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hyper transport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, a global positioning system, an internal computer network, dedicated server networks, and the like.

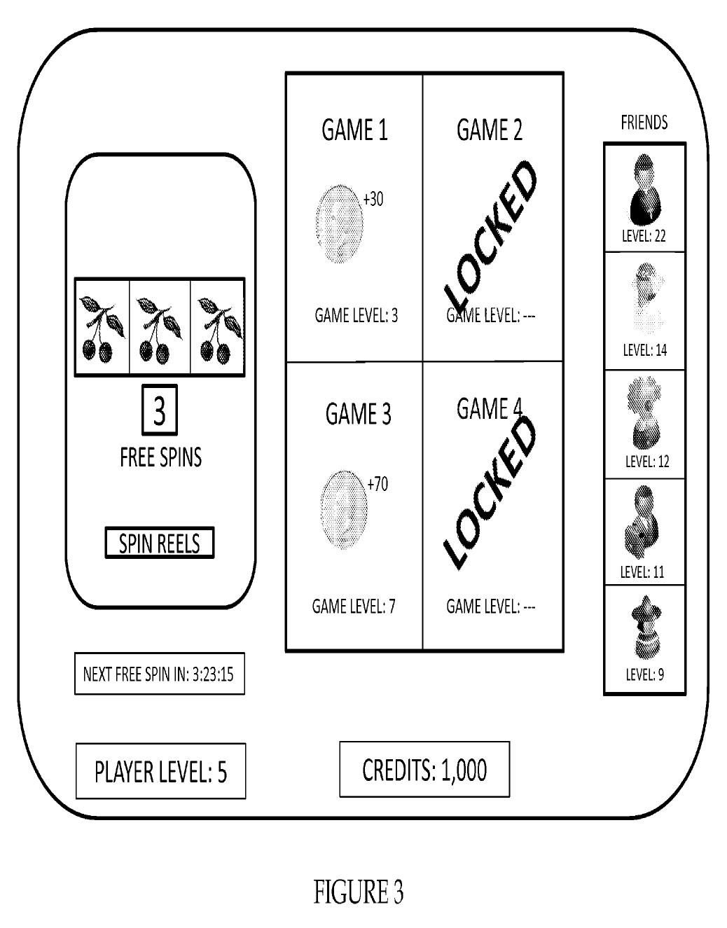

In many embodiments, as a user access the gaming system, the user's interaction with the system is through a user interface. FIG. 3 depicts a graphical display of a screenshot of an exemplary graphical user interface in accordance with one embodiment of the present invention. As shown in the Figure, a graphical user interface of the gaming system may generally comprise a first interactive section (left) and a second interactive section (center).

It should be appreciated that for some embodiments, there is a game reward engine which dictates whether to change the access status of games in particular user configurations from locked to unlocked, or from locked to preview. The game reward engine can be referred to as a specifically configured processor such as the one described in FIG. 2, and can receive information from the user input, and relayed through the message bus system, through a database system, through a series of XML files, or the like.

In some embodiments, the first interactive section generally comprises an unlocking game which may only be activated using a free credit. In many embodiments, the unlocking game comprises any type of game suitable for embodiments of the present invention, as described hereinabove. In the embodiment depicted, the unlocking game comprises a slot-type game having a plurality of reels having a multitude of symbols thereon. As with ordinary slot games, by spinning the reels (i.e., using a free credit/spin to spin the reels), a randomly generated set of symbols will appear in one or more “paylines” of the unlocking game.

If the unlocking game results in an unlock, a message is sent through the message bus to the reward campaign engine in real time and the reward campaign engine changes the game status in the particular user configuration using real time scripts, or the like. Alternatively, the reward campaign engine could award an unlock event if a user configuration player level reaches a predetermined milestone.

In some embodiments, the user selects the game to unlock and in some embodiments, the reward campaign engine determines what game to unlock. The reward campaign could change a game status to unlock or preview for all user configurations, or a particular subset of users, at a particular time.

The first interactive section may further comprise a means for accruing more free credits. In one embodiment, the free credits can be accrued using a timer, whereby a user must wait a set amount of time before a free credit is given to the user for use in the unlocking game. In another embodiment, a free credit may be accrued every time a user increases a “player level.” A player level may be an algorithmic measurement of a user's performance within the gaming system. It may be indicative of time played, number of games played, consecutive days visited, number of “friends” also playing the games, combinations thereof, or the like.

In many embodiments, when a winning set of symbols appear on the payline(s) of the unlocking game, the user may be awarded with a winning prize by the reward campaign engine. The winning prize may be one or more of an amount of credits, a free spin, a “level up” of the player level, or an unlocking prize that may unlock one or more games as described herein. In certain embodiments, in order to lock one or more games of the gaming system, a user must get each of a particular game's name, symbol, logo, etc., in a payline on the unlocking game. In some embodiments, it may be feasible to unlock every game within the gaming system without ever having played any of such games.

The second interactive section generally comprises a listing of games available within the gaming system, optionally shown in a grid display. In one embodiment of the present invention, the games are typically provided in a “locked” state, such that a user cannot access a game for play. This is accomplished by setting the default game status of all the games in the user configuration to ‘locked.’ Often, however, at least a first game is unlocked for the user to play immediately (i.e. the game status in the user configuration is ‘unlocked’). Once “unlocked” as described below, a user may click on such game and have access to playing the game.

Along with being able access the game, once a game is unlocked, a user may be able to accrue coins or credits from each game. For example, as shown in the Figure, by clicking on a coin symbol within the game, the user may be able to add a set number of credits to the user's overall credits. Similar to the free spins, the credits may appear periodically or by some other means of accumulation.

Similar to the player level, described supra, each game may have a “game level” that the user may attain. In many embodiments, the game level of a certain game may be an algorithmic measurement of a user's performance of that game, based upon either number of credits wagered, credits won, quantity of times played, consecutive days played, number of “friends” also playing the game, combinations thereof or the like.

The value of a user's game level may allow the user certain benefits within the gaming system. For example, in one embodiment, specialty games and/or features within a game may become available if a user has a particular game level for one or more of the games within the gaming system. In another embodiment, the free credits given from each game may be valued based upon the game level (e.g., in the Figure, Game 1 is a game level 3 and gives 30 credits, whereas Game 3 is a game level 7 and gives 70 credits). In further examples, additional benefits may be awarded for highest game levels.

In various embodiments of the present invention, revenue may be generated for access to and utilization of the system. For example, the administrator may charge a user access fee, in either a one-time or per use amount. In one embodiment of the present invention, the system may be designed to interact with users in possession of an Apple iPhone. In such instance, users may be required to purchase the “application” in order to utilize the systems and features disclosed herein. In an alternative embodiment, users may be allowed to access features of embodiments of the present invention, and will be billed at a subsequent date for the amount of data transferred to and from such user. Alternative embodiments contemplate utilizing any known method for acquiring fees for the sale or license of software application utilized by mobile devices, as known in the industry.

In other embodiments, revenue streams may be generated by the administrator for allowing third party advertisements or sponsorships within features of the system. In one embodiment, such third party advertisements may come in the form of ad banner sponsorships (either fixed fee, cost per click (CPC) or cost per mille (CPM)—based billing), text sponsorships (either MMS or SMS -type messages), location-based (geo-targeted) advertising (e.g., “Check out this Game, it's the Best!”), or email sponsorship to users of the system. In other embodiments, any known advertising through mobile devices or web-based may be utilized for purposes of increasing revenue to the administrator of embodiments of the present invention.

In accordance with other embodiments of the present invention, the systems and methods disclosed herein may further be provided with basic social networking capabilities. For example, sub-user groups (a.k.a. “friends”) may be created, postings and messaging may take place, and additional user information may be stored. In many of such embodiments, a listing of the user's friends may be shown on a side of the graphical user interface.

In certain embodiments, the systems and methods of embodiments of the present invention may be utilized in conjunction with or as an application to third party social networking sites (e.g., Facebook, MySpace, Foursquare, or the like). By doing so, the administrator may be able to utilize the expansive network of already existing users of such third party sites to increase the number of users of systems and methods of the present invention.

While the foregoing is directed to embodiments of the present invention, other and further embodiments of the invention may be devised without departing from the basic scope thereof. Furthermore, whereas the multitude of embodiments disclosed herein each provides a variety of elements within each embodiment, it should be appreciated any combination of elements from any combination of embodiments is well within the scope of further embodiments of the present invention.

1. A system of providing a gaming system accessible via a global computer network, the system comprising:
an administrator comprising a host computer, accessible via a global computer network, the host computer comprising a tangible computer readable medium comprising program instructions, wherein the program instructions are computer-executable to implement:
hosting a gaming platform, whereby the gaming platform comprises
a reward campaign engine;
a plurality of user configurations wherein each user configuration comprises:
an index to a plurality of games wherein the index comprises a game access status for each game; and
a user credit balance;
access to plurality of games, the access status of the games for a user indicated by the associated user configuration;
enabling the user to play the games whose game access status is unlocked at any time and not enabling the user to play the games whose game access status is locked through a graphical user interface of the gaming platform wherein the outcome of the games affects the user credit balance; and
an event, triggered by the reward campaign engine, wherein the occurrence of the event modifies the user configuration.

2. The system of claim 1, wherein the event is based on the outcome of an independent game not in the game index.

3. The system of claim 1, wherein each of the plurality of games in the user configuration are each slot-type games.

4. The system of claim 1 wherein, upon the outcome of the event, the user is given the choice of which game status to change to unlock.

5. The system of claim 1, wherein the reward campaign engine determines which game status to change to unlock.

6. The system of claim 1, wherein the reward campaign engine changes the game status to unlock for a specified period of time.

7. The system of claim 1, wherein the user configuration further comprises a player level and wherein predetermined player levels trigger the event.

8. A machine comprising:
a reward campaign engine;
a plurality of user configurations, stored on a memory, wherein each user configuration comprises:
an index to a plurality of games wherein the index comprises a game access status for each game; and
a user credit balance;
a user interface enabling a user to play the games whose game access status is unlocked at any time and not enabling the user to play the games whose game access status is locked wherein the outcome of the games affects the user credit balance; and
an event, triggered by the reward campaign engine, wherein the occurrence of the event modifies the user configuration.

9. The machine of claim 8 wherein the event is based on the outcome of an independent game not in the game index.

10. The machine of claim 9 wherein the independent game is a slot-style game.

11. The machine of claim 8 wherein each of the plurality of games in the user configuration are each slot-type games.

12. The machine of claim 8 wherein, upon the outcome of the event, the user is given the choice of which game status to change to unlock.

13. The machine of claim 8 wherein the reward campaign engine determines which game status to change to unlock.

14. The machine of claim 8 wherein the user configuration further comprises a player level and wherein predetermined player level triggers the event.

15. A method of providing a gaming platform comprising:
enabling a plurality of users, including a first user, to play a gaming platform, the gaming platform comprising:
a reward campaign engine; and
a plurality of user configurations, one for each user, wherein each user configuration comprises:
an index to a plurality of games, stored on a memory, wherein the index comprises a game access status for each game; and
a user credit balance;
enabling the user access to play the games whose game access status is unlocked at any time and not enabling the user to play the games whose game access status is locked, through a graphical user interface, wherein the outcome of the games affects the user credit balance; and
modifying the user configuration if an event, triggered by the reward campaign engine, occurs.

16. The method of claim 15 wherein the event is based on the outcome of an independent game not in the game index.

17. The method of claim 16 wherein the independent game is a slot-style game.

18. The method of claim 15 wherein each of the plurality of games in the user configuration are slot-style games.

19. The method of claim 15 wherein upon the outcome of the event, the user is given the choice of which game status to change to unlock.

20. The method of claim 15 wherein the user configuration further comprises a player level wherein predetermined player levels trigger the event.
